(19) United States
(12) Patent Application Publication
(10) Pub. No.: US 2026/0333553 A1
(43) Pub. Date: Oct. 22, 2026

(54) BUILDING LIGHTING SYSTEM WITH POWER AND DATA CONNECTIVITY

(71) Applicant: Essata Technologies Incorporated, Nunica, MI (US)

(72) Inventors: Ted A. Dekker, Norton Shores, MI (US); Gregory A. Swears, Nunica, MI (US)

(21) Appl. No.: 19/328,433

(22) Filed: Sep. 15, 2025

Related U.S. Application Data
(60) Provisional application No. 63/790,147, filed on Apr. 17, 2025.
(60) Provisional application No. 63/790,160, filed on Apr. 17, 2025.

(51) Int. Cl. H05B 47/175; H05B 45/10; H05B 45/37; H05B 47/11; H05B 47/115; H05B 47/155; H05B 47/165; H05B 47/18; H05B 47/185; H05B 47/19

(52) U.S. Cl. CPC H05B 47/1985; H05B 45/10; H05B 45/37; H05B 47/11; H05B 47/115; H05B 47/155; H05B 47/165; H05B 47/18; H05B 47/187; H05B 47/19

(57) ABSTRACT

A lighting system includes a hub; building network devices; a power bus network configured to provide power from the hub to the building network devices; and a data bus network configured to communicatively couple the hub to the building network devices. The hub configured to receive, via the data bus network, a data signal from at least one first building network device and, in response to the data signal, to transmit an activation command to at least one second building network device. The hub, the building network devices, the power bus network, and the data bus network collectively define a lighting zone

### CROSS REFERENCE TO RELATED APPLICATIONS

This application claims the benefit of priority to U.S. Provisional Patent Application Nos. 63/790160 and 63/790147, each filed on 17 Apr. 2025, the entire contents of each of which are incorporated herein by reference.

### TECHNICAL FIELD

The present disclosure relates generally to lighting systems for buildings, especially buildings within industrial environments. In particular, the disclosure relates to lighting systems that provide both power and data connectivity between devices and a central hub.

### BACKGROUND

Conventional lighting systems in commercial, industrial, and residential buildings can group light fixtures, user controls, and environmental sensors into zones. In such lighting systems, zones are wired for power and analog control (e.g., 0 to 10 V dimming). Within a zone, photometric output from each light fixture can be made the same. The photometric output from the light fixtures can be adjusted by one or more controllers associated with the zone.

Conventional lighting systems that operate within commercial and residential buildings typically regulate a power signal to control a lighting load. That is, in conventional lighting systems, operation is typically controlled by adjusting the power supplied to a luminaire, such as through power switching, phase-cut dimming, or by sending an analog control signal (e.g., 0 to 10 V or 1 to 10 V dimming). Even in Networked Lighting Control systems and other digital control architectures, where overall system operation is managed by software, analog signals can be used to control activations of individual luminaires.

### SUMMARY

In some aspects, the techniques described herein relate to a lighting system, including: a hub; a plurality of building network devices; a power bus network configured to provide power from the hub to the plurality of building network devices; and a data bus network configured to communicatively couple the hub to the plurality of building network devices, wherein the hub is configured to receive, via the data bus network, a data signal from at least one first building network device and, in response to the data signal, to transmit an activation command to at least one second building network device. The hub, the building network devices, the power bus network, and the data bus network collectively define a lighting zone.

In some aspects, the techniques described herein relate to a lighting system, wherein the hub includes a controller configured to receive the data signal from the at least one first building network device and to transmit at least one control command to the at least one second building network device over the data bus network to control photometric output of those network devices, the activation command generated at the hub in response to the data signal from the at least one first building network device.

In some aspects, the techniques described herein relate to a lighting system, wherein the data signal received by the hub from the at least one first building network device includes the activation command, wherein the hub is configured to relay the activation command from the at least one first building network device to the at least one second building network device over the data bus network to control photometric output of the at least one second building network device.

In some aspects, the techniques described herein relate to a lighting system, wherein the plurality of building network devices includes at least one luminaire, at least one motion sensor, and at least one switch.

In some aspects, the techniques described herein relate to a lighting system, wherein the data bus network includes at least one serial data bus.

In some aspects, the techniques described herein relate to a lighting system, wherein the plurality of building network devices includes a first subset of building network devices and a second subset of building network devices, and wherein the data bus network includes a first serial data bus and a second serial data bus, the first subset of building network devices operatively coupled to the hub through the first serial data bus, and the second subset of building network devices operatively coupled to the hub through the second serial data bus.

In some aspects, the techniques described herein relate to a lighting system, wherein the hub is powered by a line voltage power source.

In some aspects, the techniques described herein relate to a lighting system, wherein the hub includes an AC-DC power converter configured to convert AC line voltage to low-voltage DC, the power bus network powering the plurality of building network devices.

In some aspects, the techniques described herein relate to a lighting system, wherein the power bus network includes at least one low-voltage DC power bus.

In some aspects, the techniques described herein relate to a lighting system, wherein the at least one low-voltage DC power bus provides a voltage of less than 60 volts and is limited to a maximum power output of 100 watts.

In some aspects, the techniques described herein relate to a lighting system, further including a wireless network operatively coupling the hub to the plurality of building network devices, wherein each of the network devices includes a wireless communication module operable to wirelessly communicate with the hub.

In some aspects, the techniques described herein relate to a lighting system, wherein the wireless communication module in each of the building network devices is operable to wirelessly communicate with the other building network devices in the plurality of building network devices.

In some aspects, the techniques described herein relate to a lighting system, wherein the hub includes one or more Ethernet ports, the power bus network and the data bus network operatively coupled to the hub through the one or more Ethernet ports.

In some aspects, the techniques described herein relate to a lighting system, wherein each of the plurality of building network devices includes embedded firmware logic configured to send data signals along the data bus network.

In some aspects, the techniques described herein relate to a lighting system, wherein the power bus network and the data bus network are combined in common multi-conductor cables.

In some aspects, the techniques described herein relate to a zoned lighting system for use in a building, including: a first lighting zone having a first hub and a plurality of first network devices, the first hub being configured to supply power to the first network devices and to communicate with the first network devices via a first data bus network; and a second lighting zone having a second hub and a plurality of second network devices, the second hub being configured to supply power to the second network devices and to communicate with the second network devices via a second data bus network.

In some aspects, the techniques described herein relate to a zoned lighting system, wherein at least some of the first network devices are configured to be activated by the first hub to illuminate areas within a building, wherein at least some of the second network devices are configured to be activated by the second hub to illuminate areas within the building.

In some aspects, the techniques described herein relate to a zoned lighting system, wherein the first data bus network is a first serial data bus network, and the second data bus network is a second serial bus network.

In some aspects, the techniques described herein relate to a method of controlling a lighting system within a building, the method including: supplying low-voltage direct current (DC) power from a hub to a plurality of network devices over a power bus network; communicating data signals between the hub and the plurality of network devices over a data bus network, the data signals including at least one control command; receiving, at the hub, a data signal transmitted from a first network device through the data bus network; and in response to the data signal, transmitting from the hub an activation signal to at least one second network device over the data bus network to cause a change in photometric output of the at least one second network device, wherein the power bus network and the data bus network are provided, at least in part, through common multi-conductor cables extending between the hub and the plurality of network devices.

In some aspects, the techniques described herein relate to a method, wherein the at least one second network device includes at least one luminaire within a lighting zone.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 is a schematic view of a lighting system for a building.

FIG. 2 is a schematic view of a zone from the lighting system of FIG. 1 according to an exemplary embodiment of the present disclosure.

### DETAILED DESCRIPTION

The present disclosure describes exemplary lighting systems and lighting methods that can be used within, for example, a commercial office building or a building within an industrial environment, such as a factory or a warehouse. The lighting systems and methods can rely on a data bus network to control lighting devices within a particular zone. In some examples, the lighting system includes combined low-voltage power and data networks to form a zone-level lighting infrastructure.

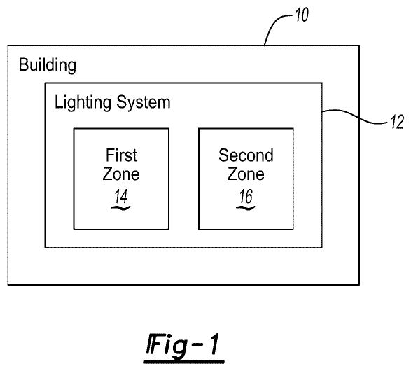

With reference to FIG. 1, a building 10 includes an example lighting system 12 having multiple lighting zones. In the illustrated example, the lighting system 12 includes a first lighting zone 14 and at least one second lighting zone 16. The first lighting zone 14 and the at least one second lighting zone can operate independently from each other.

Although the description herein focuses on the first lighting zone 14, the at least one second lighting zone 16 can have a similar configuration to the first lighting zone 14, and in some embodiments may include additional, fewer, or alternative components, features, or arrangements. The first lighting zone 14 and the at least one second lighting zone 16 may have similar or different configurations and may share or not share components.

For purposes of this disclosure, a lighting zone refers to a spatial or logical grouping of one or more luminaires and associated control devices configured to operative collectively according to a predefined control logic, such as on/off switching, dimming, or occupancy sensing. Within a lighting zone, all the luminaires respond together to control inputs (e.g., all luminaires dim to 50% when unoccupied). Essentially, a “lighting zone” includes a logical or physical grouping of lighting components that are collectively controlled based on at least one shared control parameter, such as dimming level, on/off state, or occupancy response.

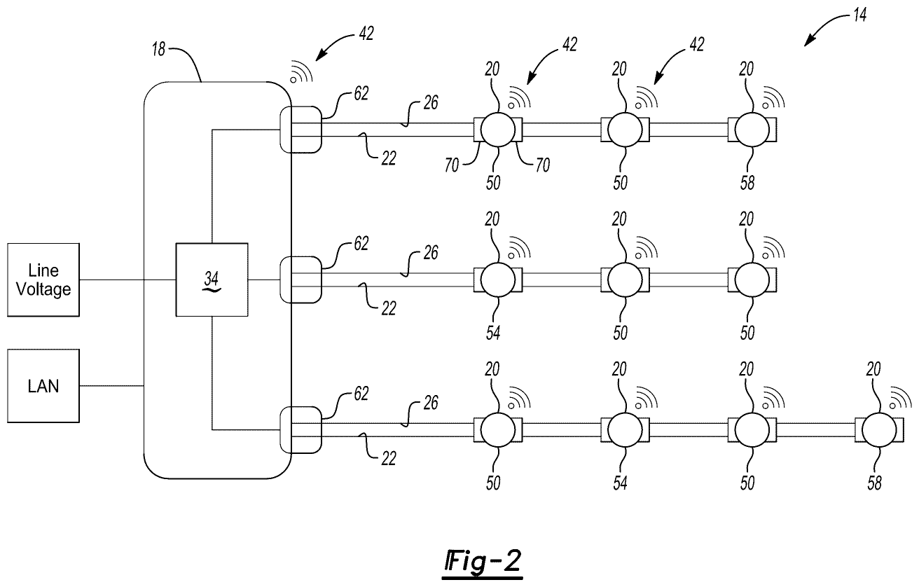

With reference to FIG. 2, the first lighting zone 14 of the lighting system 12 includes a hub 18, a plurality of network devices 20, a power bus network 22, and a data bus network 26. The power bus network 22 is configured to provide low-voltage direct current (DC) power from the hub 18 to the network devices 20. The data bus network 26 is configured to provide communication between the hub 18 and the network devices 20.

As used herein, “network device” refers to any luminaire, lighting fixture, controller, sensor, or related component operable to receive power from the power bus network 22 and to exchange data signals with the hub 18 via the data bus network 26. In this example, the network devices 20 include luminaires 50, motion sensors 54, and switches 58. In some examples, the network devices 20 can be considered nodes. Each of the luminaires 50 within the zone emits a common photometric output in response to a command from the hub 18. In this example, each of the luminaires 50 includes a load controller configured to adjust a photometric output.

The example hub 18 is connected to a local area network (LAN) and can be powered by standard line voltage (e.g., 120-277 V AC), such as that commonly found in residential or commercial buildings. The hub 18 includes a power supply 34 that converts AC line voltage to low-voltage DC.

The network devices 20 can be powered by the power bus network 22 extending from the hub 18 to the network devices 20. The power supply of the hub 18 can power the network devices 20 through the power bus network 22 using National Electrical Code (NEC) Class 2 low-voltage DC, which provides a voltage of less than 60 volts and is limited to a maximum power output of 100 watts.

The data bus network 26 may use one or more serial data buses (e.g., CAN bus), with each bus associated with a port 62 on the hub 18. In the exemplary embodiment, the hub 18 is configured to receive a command from one of the network devices 20 sent along a serial bus of the data bus network and to activate another of the network devices 20 (e.g., the luminaires 50) in response to the command. This can facilitate zone-level control without requiring multiple control wires. The network device 20 can be connected in a star topology, with optional daisy-chaining between devices.

Terminating resistors may be installed manually or automatically by devices detecting their position on the data bus network 26. The last network device 20 in a daisy-chained series of network devices 20 can, for example, can include a terminating resistor. In another embodiment, the circuitry can automatically sense the presence of upstream or downstream network devices 20 on the data bus network 26. If the network device 20 assesses that it at an end of the data bus network, that network device 20 can automatically apply a terminating resistor.

In this example, the lighting system 12 additionally includes wireless network 42 to allow wireless communication between the network devices 20 and the hub 18. The wireless network 42 can instead or additionally be used for communication with the network devices 20 and the hub 18 from outside the lighting system 12. The wireless network 42 can use mesh protocols such as Bluetooth mesh or Zigbee. The hub 18 can include a WiFi radio to provide connectivity to a network outside the lighting system 12, such as a building wireless network. This connection can provide the lighting system 12 with an internet connection.

The wireless network 42 may be implemented using mesh protocols, enabling redundancy and simplified commissioning. In some embodiments, network devices include both wired and wireless communication capabilities, with the hub bridging between them.

In the exemplary embodiment, the power bus network 22 and the data bus network 26 are, at least in part, provided by a plurality of multi-conductor cables 66, which can include a plurality of insulated conductors bundled together within a single outer jacket.

The network devices 20 can include circuitry permitting communication on the data bus network 26. The circuitry can include microcontrollers. In some examples, network devices 20 can each include a microcontroller to communicate on the data bus network 26 and another microcontroller to communicate on the wireless network 42.

In this example, the multi-conductor cables 66 are Ethernet cables that engage the hub 18 and one or more of the network devices 20 through the ports 62 or other physical/data interfaces. The ports 62 can each have a current and voltage-limited output of less than 60 VDC and 100 W total load. The network devices 20 can each include at least two ports 70 to enable the daisy-chaining.

The lighting system 12 can be configured in centralized or decentralized architectures, and in some cases operates as a nanogrid lighting system. A nanogrid can be a relatively small-scale, self-contained system that operates similarly to a microgrid, but on a smaller footprint. As used herein, the “nanogrid” refers to a localized electrical power distribution network having a rated capacity of less than 100 kW and configured to serve a single zone, such as a single building, room, or area.

The nanogrid can, as in the exemplary embodiment, operate in a grid-connected mode, in which the nanogrid is powered by a utility grid. In some examples, the nanogrid could operate in an islanded mode where the nanogrid is electrically isolated from the utility grid and serves loads using local generation, storage, or both. In such examples, the loads could be served using at least one local energy source (e.g., photovoltaic array, wind turbine, fuel cell), one or more energy storage devices (e.g., batteries, capacitors), and a power management system that regulates power flow among the sources, storage devices, and loads.

In one embodiment, the hub 18 receives the AC line voltage (e.g., 120-277 VAC) and performs an AC-DC conversion to a DC voltage below 60 VDC, in keeping with NEC Class 2 requirements. In this example, the hub 18 provides a Class 2 low-voltage DC output (e.g., 48 VDC). This output is provided over the power bus network 22 to the network devices 20 via Ethernet or other multi-conductor cables. At least two of the conductors within the multi-conductor cables 66 and provide power to the network devices 20. At least two other conductors can communicate data signals. The multi-conductor cables 66 can thus bundle both power and data transmission. The multi-conductor cables 66 can include conductors that are copper, optical fiber (for data), or hybrid power/data cables.

The system, in some examples, is thus configured to deliver power and data over common Ethernet connections as a Power over Ethernet (PoE) system. In other examples, the hub 18 can receive a DC power input, complete a DC-DC conversion, and provide Class 2 power to Network Devices.

At least some of the network devices 20 of the lighting system 12 could be or could include lighting load controllers, such as LED drivers and zone controllers, and environmental sensors such as light sensors and motion sensors. The lighting load controllers may include LED drivers configured for constant current or constant voltage output, with optional emergency lighting battery connections and ports for sensors or other peripherals. The LED drivers can each include a first driver port for coupling to an emergency lighting battery. The LED drivers can each include a second driver port for coupled to a sensing peripheral. The second driver port can be a multi-conductor port that provides low-voltage power (typically between 5 and 12 VDC) for powering the sensing peripheral, and a serial data connection. Typical sensing peripherals include air temperature and humidity sensors, motion sensors, asset locating anchors, etc.

The zone controllers can, in some examples, output an analog or digital control signal for control of conventional LED Drivers or lighting loads. Zone controllers may, for example, output industry-standard control signals or relay outputs for conventional fixtures. These control signals include industry-standard lighting control signals, including but not limited to 0/1 to 10 V dimming, relay control, TRIAC, ELV, or DALI.

As used herein, a “TRIAC” (Triode for Alternating Current) is a bidirectional semiconductor switching device used to control alternating current (AC) power, such as in phase-cut light dimmers and “ELV” (Electronic Low-Voltage) refers to a lighting control protocol in which the AC voltage waveform supplied to a load is modified using reverse-phase (trailing-edge) dimming, typically implemented with electronic transformers for low-voltage lighting systems. “DALI” (Digital Addressable Lighting Interface) can refer to a standardized, two-wire digital communication protocol for lighting control systems, enabling individual or group addressing of lighting devices and bidirectional exchange of control and status information.

In some examples, the zone controller can receive a line voltage power input (100 to 277 VAC) in addition to the network connection. One or more conventional light fixtures can be connected to the zone controller output, thereby controlling their photometric output.

At least some of the network devices 20 can be characterized as environmental sensors, which can be switch adaptors, light switches, motion and light sensors, or non-lighting devices. These may transmit data signals to the hub 18 or directly to other network devices 20, depending on the architecture. The data signals transmitted to the hub 18 can include control commands.

In an example, the switch adaptor is a device that can receive an analog control signal from a conventional lighting switch. These analog control signals include industry-standard lighting control signals, including but not limited to 0/1 to 10 V dimming, relay control, TRIAC, or ELV. The Switch Adapter interprets the control signal, resolving to a percentage of intended photometric output (e.g., 5 V dimming signal from a 0 to 10 V dimmer switch equals 50%). This percentage can be reported to another of the network device 20 or to the hub 18 by means of the data bus network 26 or the wireless network 42.

A light switch is one of the network devices 20 that that can serve as a user controller of lighting. The light switch can be presented to the user in a similar form to conventional switches, including but not limited to single-pole, double-pole, or dimmer switches. The button style may include toggle, rocker, or push-button. The light switch may include multiple buttons or sliders for the control of multiple zones, or the control of both photometric output and light temperature. When the user presses a button on the light switch, the signal is interpreted as an intended system behavioral change, whether to turn luminaires 50 on, off, or dim to a new level of light output.

The motion and light sensors are the network device 20 that senses either human motion or ambient luminaire, or both. Human movement can be sensed using one or multiple technologies including, but not limited to, passive infrared or ultrasonic. The ambient light level is can be sensed in different ways, including, but not limited to, phototransistors, photodiodes, and photo integrated circuits.

The lighting system 12 could still further include non-lighting devices, such as HVAC controllers or location beacons, that benefit from the low-voltage power and data capabilities of the lighting system 12. The network devices 20 that are non-lighting devices can a purpose in the building outside of the lighting system 12, but may benefit from using either the low-voltage power provided by the power bus network 22, the data connectivity provided by the data bus network 26, or both. These devices may include but are not limited to locating anchors (e.g., Bluetooth angle of arrival anchor, HVAC controllers, etc.).

Within the lighting system 12 of this example, embedded software logic creates the system-level functionality of a lighting zone within a building's lighting system. The system can work in context of four types of lighting control schemes: basic lighting control, wireless networked lighting control, wired networked lighting control, and an integrated wired/wireless networked lighting control system or building management system.

In centralized control embodiments, the hub 18 can maintain a registry of the network devices 20, can store zone control parameters (e.g., high-end trim, fade rates, dimming curves), and can send activation commands to lighting load controllers of the network devices 20. In decentralized (or distributed) control embodiments, commands sent to the hub 18 can be relayed without additional processing. Within the lighting system 12, the hardware for both architectures can be the same, but the software logic can be different.

In particular, in the centralized control embodiments, one or more of the network devices 20 that are environmental sensors (motion sensors, light switches, etc.) collect data from the environment and users. The collected data sent from the individual network devices 20 to the hub via the data bus network 26. The data may indicate a user's desired system output in the form of lighting zone photometric output. The data could also indicate the presence of people within the area of the lighting zone, or the level of ambient lighting. In the centralized control embodiments, the network devices 20 essentially report data without sending any sort of a command. The data is analyzed and acted on at the hub 18. The hub 18 can generate activation commands in response to the data.

One or more of the network devices 20 can include manual switches that allow for a user to adjust certain system behavior parameters, such as the motion timeout (duration of time luminaires 50 stay on when motion is detected, after which the luminaires 50 in a zone turn off), ambient light dimming levels, or high-end trim. The user input set by each of these switches is read by the microcontroller within the respective network device and can be sent to the hub 18 as a user input for system performance.

The hub 18 can provide core network and lighting zone control for the lighting system 12. The hub 18 can maintain a registry of individually-addresses for each of the network devices 20 operably coupled to the hub 18 through the data bus network 26. Basic state data about each of the network devices 20 can be stored, describing all inputs from and outputs to the network devices 20, energy consumption, and other data. The hub 18 can maintain a set point for system performance parameters required for a fully functional lighting zone, including but not limited to, parameters such as motion time-out duration, high-end trim, fade on time, fade off time, step dimming parameters, dimming curve.

Based on core lighting control logic, user and environmental inputs, the hub 18 maintains the desired current functional state of the lighting zone (i.e., the current photometric output of all luminaires 50 in the zone.)

When a photometric output of the luminaires 50 should change due to system behavior logic (e.g., timers) or direct user input, the hub 18 can broadcast a message to all lighting load controllers (i.e., Zone Controllers or LED Drivers) to adjust their output signals accordingly. Confirmation messages and feedback sensing can be completed within the individual devices for reliability, to ensure that the lighting load controller output is desirable, and to identify hardware or software failures.

Examples scenarios where the photometric output of the luminaires 50 should change can include a scenario where a photometric output from one of the luminaires 50 is at 0%, and one of the motion sensors 54 senses motion and reports that data to the hub 18. In response, the hub 18 broadcasts a message to all lighting load controllers on all serial data busses of the data bus network 26 to adjust their output to 100%. If high-end trim of 80% were enabled, the hub 18 can broadcast the command to set output to 80%.

In another example scenario, the zone light fixture photometric output is at 80%, and the system motion time-out duration is set to 10 minutes. After 10 minutes with no motion detected, the hub 18 broadcasts a command to all lighting load controllers on all serial data busses of the data bus network 26 to adjust their output to 0%.

In yet another example scenario, the zone light fixture photometric output is at 0% and a user presses the “on” button on one of the switches 58. That one of the switches 58 sends this user input data to the hub, which broadcasts a command to all lighting load controllers on all serial data busses of the data bus network 26 to adjust their output to 100%.

In yet another example scenario, the zone light fixture photometric output is at 80% and a user adjusts the dimming slide on a conventional TRIAC wall dimmer to 50% output. The wall dimmer is an example one of the switches 58. A switch adapter senses the TRIAC input, resolves the AC waveform to a percentage of 50%, and sends this the hub 18 as the user's desired zone photometric output level. The hub 18 then broadcasts a command to all lighting load controllers on all serial data busses of the data bus network 26 to adjust their output to 50%.

In these examples, one or more network devices 20 provide information to the hub 18 as input. The information can include user inputs, environmental inputs, etc. The hub 18 then issues commands to load controllers within one or more of the network devices 20. The commands are based on the input from the one or more network devices 20, system parameters, and control logic of the hub 18.

The hub 18 can store locally, remotely, of both, data about system performance (on/off time, energy consumption, etc.). This is done passively by monitoring traffic between load controllers and environmental sensors, and actively by polling the lighting system 12 for information (e.g., polling LED Drivers for current energy consumption at a given time interval).

Load controllers of the system can control lighting loads per the commands to turn on/off/dim. An LED Driver can control the LED array(s) within one or more luminaires 50 (one of the luminaires 50 in most cases, but could control multiple fixtures when used as a remote driver) using a constant current or constant voltage drive output(s). Zone controllers can control conventional AC-powered fixtures using a conventional analog or digital control protocols.

In the event of power loss, the hub 18 stores last-state zone photometric light output in non-volatile memory. When power is restored, the hub 18 broadcasts a command to all lighting load controllers on all serial data busses to adjust their output to last state.

In the decentralized control embodiments, some of the network devices 20 (motion sensors, light switches, etc.), can collect data from the environment and users. The data can indicate a user's desired system output in the form of lighting zone photometric output. The data could also indicate the presence of people within the area of the lighting zone, or the level of ambient lighting. These network devices 20 can include logic that describes how conventional lighting system would operate, given an input (e.g., a user presses a light switch to turn luminaires 50 on, all light fixture photometric output goes to 100%). When an event is triggered, the environmental sensor sends a command to the hub 18 for all luminaires 50 to adjust their output accordingly. In the decentralized control environments, the hub 18 relays information and logic can be stored within the individual network devices 20. The hub 18 is not generating and originating activation commands.

The hub 18 can receive the activation command from one of the network devices 20 and can relay that activation command on the serial buses of the data bus network 26 to all lighting load controllers, which can receive the command and adjust their outputs accordingly to achieve the desired system (lighting zone) behavior.

In the decentralized control embodiments, the hub 18 performs the same tasks of storing system performance data, and providing reliability checks to ensure the lighting system 12 is performing correctly.

In some examples, the lighting system 12 can be used and configured to include wireless networked lighting control. In this configuration, the power bus network 22 of the lighting system 12 could provide power to all the network devices 20. The data bus network 26 can then provide a data network for messages not directly associated with lighting control. Lighting control would be accomplished by the wireless network 42, where all network devices 20 communicate using convention wireless communication techniques.

The lighting system 12 may change between basic lighting control and wireless networked lighting control by using a two-chip architecture. A pulse width modulated (PWM) signal could be sourced from either a microcontroller that is communicating over the CAN bus (and contains the logic required for basic lighting control), or a wireless radio that contains the wireless networked lighting control firmware. By adjusting the source of the PWM signal the system can effectively change which MCU, and thereby which method of control (basic or wireless NLC) is being used.

The lighting system 12, through the LAN connection, may integrate with building IT/OT networks via Ethernet or Wi-Fi, allowing remote monitoring, control, and data logging. Integration with a Building Management System (BMS) or and external Networked Lighting Control (NLC) server is possible, enabling advanced scheduling and system-wide optimization.

Non-network devices, such as HVAC controllers or Bluetooth location beacons, may connect to the hub 18 to draw power and/or communicate via the data bus network of the lighting system 12.

Exemplary environments for the lighting system 12 can include a commercial office installation with homogeneous nanogrid luminaires in each zone, a warehouse installation with mixed nanogrid luminaires and conventional fixtures controlled via zone controllers, and a factory floor installation with multiple zones, each having its own hub, integrated into a facility-wide BMS.

Some features of the disclosed examples include a lighting system that use a power and data network, and that are installed and operating as a single lighting zone in a commercial building. The combined hardware and software logic enables devices on this network to imitate the operation of a conventional lighting systems, with significantly reduced installation and commissioning complexity. The lighting systems can avoid the wiring required for analog controlled lighting devise, including the switch legs and multiple additional wires are often required for 3-way and 4-way switching which is costly at initial install, and inflexible during retrofits through the life of the lighting system.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A lighting system, comprising:
a hub of a lighting zone;
a plurality of building network devices of the lighting zone;
a power bus network configured to provide power from the hub to the plurality of building network devices; and
a data bus network configured to communicatively couple the hub to the plurality of building network devices,
wherein the hub is configured to receive, via the data bus network, a data signal from at least one first building network device and, in response to the data signal, to transmit an activation command to at least one second building network device
wherein the hub, the plurality of building network devices, the power bus network, and the data bus network collectively define a lighting zone.

2. The lighting system of claim 1, wherein the hub comprises a controller configured to receive the data signal from the at least one first building network device and to transmit at least one control command to the at least one second building network device over the data bus network to control photometric output of those network devices, the activation command generated at the hub in response to the data signal from the at least one first building network device.

3. The lighting system of claim 1, wherein the data signal received by the hub from the at least one first building network device includes the activation command, wherein the hub is configured to relay the activation command from the at least one first building network device to the at least one second building network device over the data bus network to control photometric output of the at least one second building network device.

4. The lighting system of claim 1, wherein the plurality of building network devices comprises at least one luminaire, at least one motion sensor, and at least one switch.

5. The lighting system of claim 1, wherein the data bus network comprises at least one serial data bus.

6. The lighting system of claim 1, wherein the plurality of building network devices includes a first subset of building network devices and a second subset of building network devices, and wherein the data bus network comprises a first serial data bus and a second serial data bus, the first subset of building network devices operatively coupled to the hub through the first serial data bus, and the second subset of building network devices operatively coupled to the hub through the second serial data bus.

7. The lighting system of claim 1, wherein the hub is powered by a line voltage power source.

8. The lighting system of claim 1, wherein the hub includes an AC-DC power converter configured to convert AC line voltage to low-voltage DC, the power bus network powering the plurality of building network devices.

9. The lighting system of claim 1, wherein the power bus network comprises at least one low-voltage DC power bus.

10. The lighting system of claim 9, wherein the at least one low-voltage DC power bus provides a voltage of less than 60 volts and is limited to a maximum power output of 100 watts.

11. The lighting system of claim 1, further comprising a wireless network operatively coupling the hub to the plurality of building network devices, wherein each of the network devices includes a wireless communication module operable to wirelessly communicate with the hub.

12. The lighting system of claim 11, wherein the wireless communication module in each of the building network devices is operable to wirelessly communicate with the other building network devices in the plurality of building network devices.

13. The lighting system of claim 1, wherein the hub includes one or more Ethernet ports, the power bus network and the data bus network operatively coupled to the hub through the one or more Ethernet ports.

14. The lighting system of claim 1, wherein each of the plurality of building network devices includes embedded firmware logic configured to send data signals along the data bus network.

15. The lighting system of claim 1, wherein the power bus network and the data bus network are combined in common multi-conductor cables.

16. A zoned lighting system for use in a building, comprising:
a first lighting zone having a first hub and a plurality of first network devices, the first hub being configured to supply power to the first network devices and to communicate with the first network devices via a first data bus network; and
a second lighting zone having a second hub and a plurality of second network devices, the second hub being configured to supply power to the second network devices and to communicate with the second network devices via a second data bus network.

17. The zoned lighting system of claim 16, wherein at least some of the first network devices are configured to be activated by the first hub to illuminate areas within a building, wherein at least some of the second network devices are configured to be activated by the second hub to illuminate areas within the building.

18. The zoned lighting system of claim 17, wherein the first data bus network is a first serial data bus network, and the second data bus network is a second serial bus network.

19. A method of controlling a lighting system within a building, the method comprising:
supplying low-voltage direct current (DC) power from a hub to a plurality of network devices over a power bus network;
communicating data signals between the hub and the plurality of network devices over a data bus network, the data signals including at least one control command;
receiving, at the hub, a data signal transmitted from a first network device through the data bus network; and
in response to the data signal, transmitting from the hub an activation signal to at least one second network device over the data bus network to cause a change in photometric output of the at least one second network device, wherein the power bus network and the data bus network are provided, at least in part, through common multi-conductor cables extending between the hub and the plurality of network devices.

20. The method of claim 19, wherein the at least one second network device comprises at least one luminaire within a lighting zone.
